(19) United States
(12) Patent Application Publication
(10) Pub. No.: US 2026/0316313 A1
(43) Pub. Date: Oct. 15, 2026

(54) METHOD AND APPARATUS FOR NOTCHING WEB MATERIAL

(71) Applicant: I.M.A. INDUSTRIA MACCHINE AUTOMATICHE S.P.A. UNIPERSONALE, Ozzano dell'Emilia (BO) (IT)

(72) Inventor: Mario SPATAFORA, Granarolo dell'Emilia (BO) (IT)

(21) Appl. No.: 19/112,060

(22) PCT Filed: Sep. 15, 2023
(86) PCT No.: PCT/IT2023/050212

§ 371 Date: Mar. 14, 2025

(30) Foreign Application Priority Data
Sep. 15, 2022 (IT) 102022000018960

(51) Int. Cl. B26D 1/40; B26D 3/14; B26D 9/00

(52) U.S. Cl. CPC B26D 1/405; B26D 3/14; B26D 9/00

(57) ABSTRACT

The apparatus for notching web material includes a longitudinal cutting assembly including a guide roller rotatable around a respective axis, a first cutting member and a second cutting member located downstream of said first cutting member The first and second cutting members can be operated, independently of each other, in a movement towards or away from a first inactive position, in which they are respectively distant from a web material fed, in operation, between said guide roller and said first and second cutting members, and a second active position, in which they are suitable for engaging said web, material between said guide roller and said first and second cutting members, for punching out longitudinal notches on said web material

### TECHNICAL FIELD

The present invention relates to a method for notching in a longitudinal edge of a web material, as well as an apparatus for carrying out said method.

### PRIOR ART

Use of flexible web materials, equipped, either on one or on both the respective longitudinal edges, with a plurality of notches, which are for example substantially orthogonal or inclined with respect to the longitudinal direction of the web, is currently known. These notches may be made using a fixed pitch, i.e. notches are equidistant from each other, or using a variable pitch, i.e. notches are not equidistant from each other, along the longitudinal direction of the web. Furthermore, the portion of web comprised between two successive notches can be removed, so forming a notched profile of the longitudinal edge of the web.

Web materials with a longitudinal edge shaped in the described manner are used, for example, in the field of manufacture of electrical energy storage devices.

The longitudinal edge of the web material is punched out via a process known as notching, which uses mechanical or laser cutting means, implemented in automatic machines.

Apparatuses for notching web material is known, for example, from patents JP2016001575A and EP3404745A1.

A need arises in specific production sectors to make the notching operation of a web material very quick, without damaging, during this operation, the web material, which sometimes is very thin. At the same time, it must be ensured that the notching operation of a web material is performed with high precision.

Another need is to have an apparatus for punching out notches a web material that is versatile, economical and small. In fact, in the apparatuses known in the art, the devices used can be very bulky, or need to be replaced or installed in a laborious way when changes of the characteristics of the cut are required.

### SUMMARY OF THE INVENTION

The aim of the present invention is to solve the aforementioned problems, by devising a method that optimally allows the punching out of notches in a longitudinal edge of a web material.

Within this aim, it is a further object of the invention to provide a method for punching out notches in a longitudinal edge of a web material operated in an automatic machine, which ensures the achievement of a high production speed.

It is a further object of the invention to provide a method for punching out notches in a longitudinal edge of a web material that ensures the achievement of high precision.

It is a still further object of the invention to provide a method for punching out notches in a longitudinal edge of a web material capable of preserving the integrity of said web material.

Another object of the invention is to provide an apparatus capable of implementing the subject method for punching out notches in a longitudinal edge of a web material, which has simple constructive and functional design, reliable operation, versatile use, as well as relatively economical cost.

It is a further object of the invention to provide an apparatus that is compact and that allows to easily change the characteristics of the notches to be punched out.

The aforementioned objects are achieved, according to the present invention, by the apparatus and method for punching out notches in a longitudinal edge of a web material according to the present application.

The apparatus for notching web material comprises a longitudinal cutting assembly, comprising a guide roller rotatable around a respective axis, a first cutting member and a second cutting member, located downstream of said first cutting member.

Preferably, the first and second cutting members can be moved, independently of each other, towards or away between a first inactive position, in which they are away from the web material, and a second active position, in which they are adapted to engage the web material, fed, in operation, between the guide roller and the first and second cutting members, to punch out longitudinal notches on the web material.

Preferably, the first cutting member is shaped like a circular blade and is rotatable around a respective axis.

Preferably, the second cutting member is shaped like a circular segment blade and is rotatable around a respective axis.

Preferably, the first and second cutting members are placed at the ends of respective arms which can be operated in a tilting motion.

The method for punching out a shaped cut in a web material involves feeding a web material to a longitudinal cutting assembly comprising a guide roller driven in rotation about an axis, a first cutting member and a second cutting member placed downstream of said first cutting member.

Subsequently, the method involves moving the first cutting member towards, from a first inactive position, in which it is away from the web material, to a second active position, in which it is suitable for engaging the web material in advance between the guide roller and the first cutting member, making a longitudinal notch on the web material.

Subsequently, the method involves moving away the first cutting member from the second active position to the first inactive position and, in an appropriate phase relationship, activating the second cutting member in an approaching movement, from a first inactive position, in which is located away from the web material, to a second active position, in which it is capable of engaging the travelling web material between the guide roller and the second cutting member, punching out a longitudinal notch to finish an edge of said longitudinal notch previously punched out.

Finally, the method involves operating the second cutting device in moving away motion from the second active position to the first inactive position.

Preferably, the second cutting device is actuated in the second active position in a phase relation such that the second cutting device engages the margin to be finished of the said longitudinal notch previously punched out with a portion of the end of a respective cutting edge.

### BRIEF DESCRIPTION OF DRAWINGS

The details of the invention will be most evident from the detailed description of a preferred embodiment of the apparatus for notching web material, illustrated by way of example in the drawings, in which:

FIG. 1 is a lateral schematic view of the apparatus for notching web material according to the present invention;

FIG. 2 is a plan view of a portion of a web material having a notch according to the present invention;

FIG. 3 is an enlarged view of a detail of FIG. 1;

FIG. 4 is an axial section view of the second wheel bearing the respective blades, according to the invention;

FIG. 5 is an axial sectional view of the second wheel without the respective blades; and

FIG. 6 is a longitudinal sectional view of a blade and a blade locking ring.

### DETAILED DESCRIPTION

With particular reference to these figures, the apparatus for notching web material is indicated as a whole with the reference number 1.

Preferably, the apparatus 1 provides, upstream, means for feeding a web material 2, unwinding from a respective reel. The feeding means may comprise, for example, a pair of guide rollers 10, 11.

Preferably, downstream of the rollers 10, 11, according to the direction of unwinding of the web material 2, the apparatus provides a transversal cutting assembly 100, comprising a first wheel 101 and a second wheel 102.

Preferably, the first and second wheels 101, 102 are arranged side by side on the same work surface and are operable in rotation about respective parallel axes of rotation A, B. Preferably the first wheel 101 is operable in rotation by actuation means, not illustrated.

The first wheel 101 has a plurality of counter-blades 103, distributed at a peripheral edge 104 of said first wheel 101, and the second wheel 102 carries a plurality of blades 105 removably housed in respective seats 106 distributed at a peripheral edge 107 of said second wheel 102.

The first and second wheels 101, 102 are arranged so as to define therebetween a path in which the web 2 is adapted to be guided.

In particular, the first and second wheels 101, 102 are adapted to engage said web material 2, fed, in operation, between the counter-blades 103 and the blades 105, to punch out a plurality of transverse notches 400 at a longitudinal edge 401 of said web material 2.

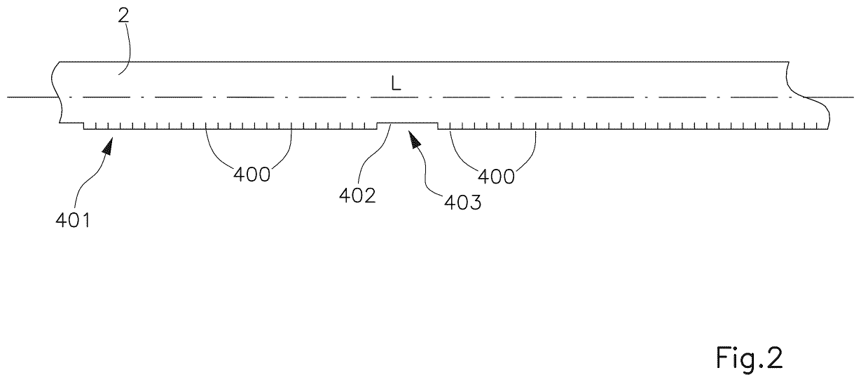

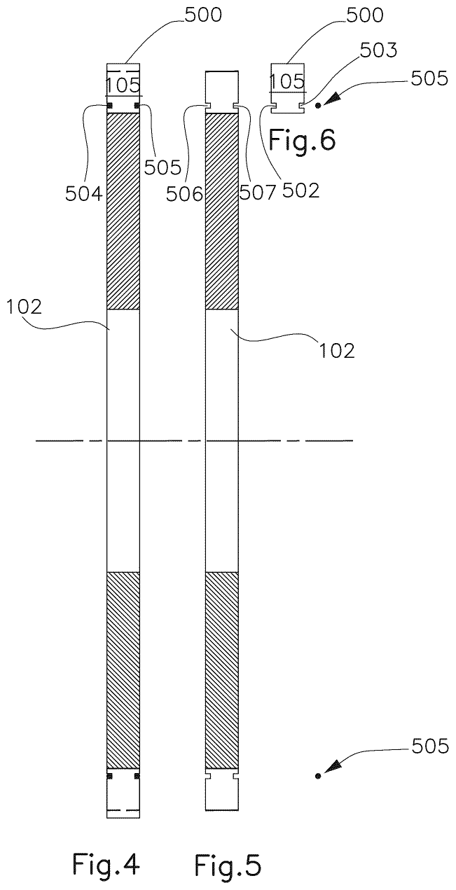

Preferably, the first and second wheels 101, 102 are mounted coaxially to respective drums, not illustrated, adapted to support, in operation, the web material 2 for the entire width of the web material 2. The first and the second wheels, on the other hand, have a width that is less than that of the web material 2, and have a width that is substantially equal to the depth of the transverse notches 400 to be punched out (see FIGS. 2 and 4). For example, the depth of the transverse notches 400 may be 4 mm.

According to the invention, the apparatus 1 provides, downstream of the transverse cutting assembly 100, a longitudinal cutting assembly 200, comprising a guide roller 201 rotatable around a respective axis C, a first cutting member 202 and a second cutting member 203 placed downstream of the first cutting member 202.

The guide roller 201, the first and the second cutting member 202, 203 are arranged so as to define therebetween a path in which the web 2 is adapted to be guided, on exiting from said transverse cutting assembly 100. It is noted that the longitudinal cutting assembly 200 can be associated with the transverse cutting assembly 100 but can also be used independently of the transverse cutting unit 100, for example to carry out the machining of a web 2 already provided with transverse notches.

In particular, the first and second cutting members 202, 203 can be operated, independently of each other, in a motion of approaching or moving away between a first inactive position, in which they are away from said web material 2, and a second active position, in which they are suitable for engaging the web material 2, fed, in operation, between the guide roller 201 and the first and second cutting members 202, 203, to punch out longitudinal notches 402 between said transverse notches 400 in the same web material 2.

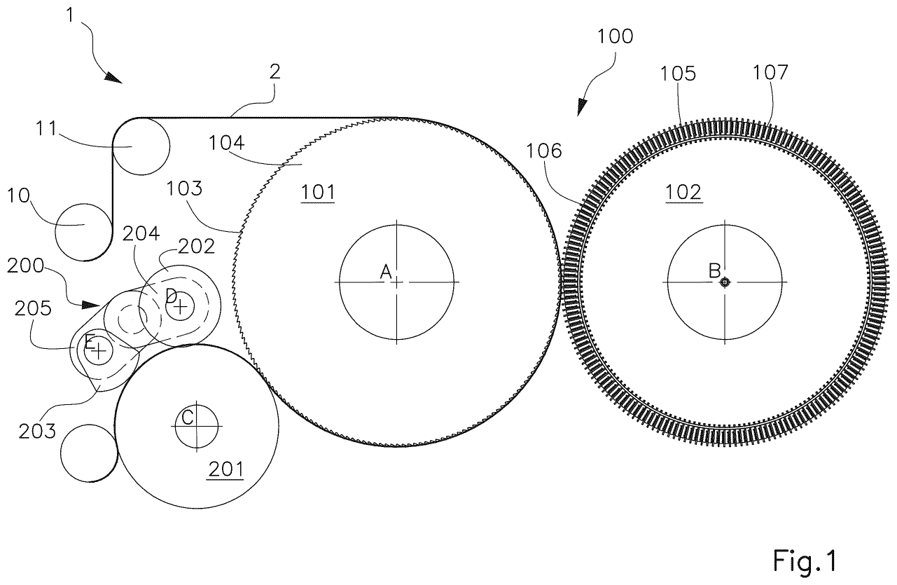

According to a preferred embodiment, illustrated in FIG. 1, the first cutting member 202 is shaped by a circular blade and is rotatable around a respective axis D. The second cutting member 203 is formed by a circular segment blade and is rotatable around a respective axis E.

In particular, the blade of the second cutting member 203 has a cutting edge that develops between the two ends that form respective corners on said cutting edge, so that the notch produced by the second cutting member 203 has respective discontinuities generated at said ends.

Preferably, the first and second cutting members 202, 203 are provided at the ends of respective arms 204, 205, operable in a tilting motion, by suitable actuation means, not illustrated.

As illustrated in particular in FIG. 2, preferably the aforementioned transverse notches 400 punched out by the cutting assembly 100 are substantially orthogonal to a longitudinal axis L of said web material 2, or are inclined with respect to said longitudinal axis L.

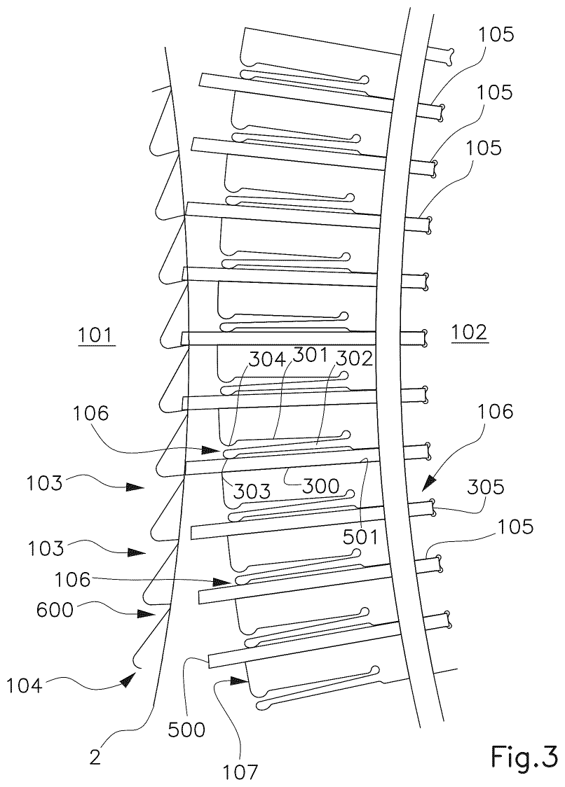

According to a preferred embodiment of the cutting assembly 100, illustrated in FIG. 3, each respective seat 106 in which each blade 105 is housed, in operation, is radially obtained in the peripheral edge 107 of the second wheel 102, so as to define at least one cutting edge 500 of said blade 105 protruding from the respective seat 106.

More in detail, as illustrated in FIG. 3, each seat 106 comprises a first flat surface 300, adapted to receive in abutment a corresponding flat face 501 of a respective blade 105. Each seat 106 also includes a second flat surface 301, opposing the aforementioned first flat surface 300, a bottom wall 305 and a flexible appendage 302 which extends between the blade 105 and the second flat surface 301.

In the illustrated embodiment, the flexible appendage 302 extends radially between an intermediate portion of the seat 106 and the peripheral edge 107.

The flexible appendage 302 and the second flat surface 301 are preferably equipped with respective end edges 303, 304 with increased thickness.

In essence, each seat 106 forms a sort of pocket suitable for receiving and containing a respective blade 105. The length of the pocket 106 is shorter than the length of the blade 105, such that, when the blade 106 is inserted until it touches the bottom wall 305 of the pocket 106, a portion of the blade 105 protrudes from the pocket 106.

Each seat 106 is made of a flexible material having elastic properties, such as rubber. Therefore, the flexible appendage 302 is capable of exerting, in operation, a compressive stress on the blade 105 in a radial direction.

Furthermore, due to the flexibility of the appendage 302, the blade 105 has freedom of movement in a radial direction. In essence, the blade 105 can move in a radial direction until the flexible appendage 302 comes in contact with the end edge 304 of the second flat surface 301.

Each counter-blade 103, carried by the peripheral edge 104 of the first wheel 101, comprises a crest 600 that extends in a radial direction, capable of cooperating with the cutting edge 500 of a corresponding blade 105 to punch out a respective transversal notch 400 at the longitudinal edge 401 of said web material 2, fed, in operation, between the blade 105 and the counter-blade 103.

Each counter-blade 103 is, in turn, made of a flexible material provided with elastic properties, such as rubber.

More in detail, the crest 600 of each counter-blade 103 is equipped with respective inclined walls, capable of guiding the blade 105, thanks to the freedom of movement in the radial direction of the latter, to precisely punch out a notch 400.

According to a preferred embodiment (see in particular FIGS. 4, 5, 6) each blade 105 is shaped by a rectangular plate, bearing the aforementioned cutting edge 500 at one end. In particular, the rectangular plate 105 has a width that is equal to the width of the second wheel 102.

More in detail, the rectangular plate 105 has a pair of indentations 502, 503 (see FIG. 6) along the sides orthogonal to the aforementioned cutting edge 500. The indentations 502, 503 are opposite each other and are suitable for housing, in operation, respective locking rings 504, 505, suitable for locking the rectangular plate 105 in position (see FIG. 4). In particular, the locking rings 504, 505 are suitable for engaging the second wheel 102 in respective circular slots 506, 507, obtained on respective lateral surfaces of the second wheel 102 so as to coincide, in operation, with the indentations 502, 503 of the rectangular plate 105, to lock the rectangular plate 105 in place on the second roller 102.

Preferably, the locking rings 504, 505 are elastic rings. The rings 504, 505 are particularly advantageous as they allow all the blades 105 to be locked in their respective seats 106 at the same time. Therefore, it is not necessary to lock each blade 105 individually, and the working time for assembly and replacement of the blades 105 is very quick.

The operation of the apparatus for notching web material is easily understood from the following description.

Preferably, in an initial phase, a web material 2 is fed to the transverse cutting assembly 100 via the feeding means 10, 11. The first wheel 101 and the second wheel 102 of the transverse cutting assembly 100 are operated in rotation, counter-rotating, around the respective axes A, B.

The web material 2 is driven forward between the wheels 101, 102 and engaged between the counter-blades 103 of the first wheel 101 and the blades 105 of the second wheel 102. By means of said blades 105 and counter-blades 103, a succession of transverse notches 400 is thus made at a longitudinal edge 401 of the web material 2.

Preferably, the web material 2, coming out of the transverse cutting assembly 100, is fed directly to the longitudinal cutting assembly 200. The guide roller 201 is operated in rotation about the respective axis C, and the web material 2 is guided in advance between the guide roller 201 and the first and second cutting members 202, 203.

Subsequently, when it is necessary to punch out a longitudinal notch 402 between the previously punched out transverse notches 400, to remove a longitudinal portion 403 of the web material (see FIG. 2), the first cutting member 202 is operated in an approaching movement, from a first inactive position, in which it is spaced away from the web material 2, to a second active position. At the same time, the first cutting member 202 is rotated around the respective axis D. In the second active position, the first cutting member 202 engages the web material 2, travelling between the guide roller 201 and the same first cutting member 202, thereby punching out, by means of the circular blade with which it is equipped, a longitudinal notch 402, thereby removing a longitudinal portion 403 of web material 2 between the aforementioned transverse notches 400.

When the longitudinal cutting has been performed, the first cutting member 202 is moved away and is returned from the second active position to the first inactive position.

In an appropriate phase relationship, the second cutting member 203 is operated in an approaching movement, from a first inactive position, in which it is away from the web material 2, to a second active position.

At the same time, the second cutting member 203 is rotated around the respective axis E. In the second active position, the second cutting member 203 engages the web material 2, travelling between the guide roller 201 and the same second cutting member 203, thus making a longitudinal finishing cut of an edge of said longitudinal notch 402 previously punched out.

When the finishing cut has been performed, the second cutting member 203 is moved away and is returned from the second active position to the first inactive position.

In particular, the finishing cut of the margin is necessary because, at high speeds of advancement of the web material 2, the time of movement of the first cutting member 202 between the first inactive position and the second active position does not allow to perform, by means of the first cutting member 202, a clear and precise cutting of the end margins of the longitudinal notch. In fact, during the movement of the first cutting member 202 between the aforementioned first and second positions, the web continues to advance in the longitudinal direction.

Advantageously, according to the present invention, the second cutting member 203 is operated in said second active position in a phase relationship such that the second cutting member 203 engages said edge to be finished of the said longitudinal notch 402, previously punched out, with an end portion of a respective cutting edge, such that the discontinuity in the cut generated by the end of the cutting edge is located at the edge of said longitudinal notch.

It is pointed out that the combination of a first cutting member and a second cutting member 202, 203 for punching out a longitudinal notch 402 is particularly advantageous.

In fact, the use of only one first cutting member 202, capable of making a continuous cut and operable towards and away from the web material to be treated, would allow to perform cuts of different length depending on the needs (for example by appropriately modifying the time in which the cutting member is in the active position). However, it would not be possible to obtain very precise cuts, in particular at the initial margin and at the final margin of the cut, since, as previously stated, during the travel of the cutting member from the active position to the inactive position, and vice versa, the web continues to advance. Therefore, since the web has considerable thickness, a clean and precise cut of the edges of the notch could only be obtained by carrying out the movement stroke of the cutting element from the active position to the inactive position, and vice versa, with a very high, theoretically infinite, speed.

Conversely, the use of only a second cutting member 203, capable of carrying out a discontinuous cut, would allow a clean and precise cut to be made of the edges of the notch, exploiting the discontinuities of the blade, whereby the cut is interrupted precisely in margin matching. However, it would be possible to punch out only a notch of predefined length, equal to the length of the portion of the blade between the discontinuities. Therefore, it would be necessary to replace the blade every time it is required to change the length of the notch.

Furthermore, very long notches would require use of very bulky blades.

The combined use of a first cutting member and a second cutting member, according to the invention, allows on the contrary to perform cuts of different lengths without replacing the blades, to use cutting members of compact dimensions and at the same time to obtain notches with a clean and precise cut of the margins.

This advantageously results in an increase in the flexibility of use and a reduction in the costs of the apparatus.

The method and the apparatus according to the present invention achieve the aim of optimally carrying out the punching out of notches in a longitudinal edge of a web material.

In particular, the method and the apparatus for punching out notches in a longitudinal edge of a web material according to the present invention make it possible to ensure a high operating speed, so as to operate effectively even in the case in which the machine is configured to operate at a very high speed.

The apparatus described by way of example is susceptible to numerous modifications and variations according to different needs.

In the practical embodiment of the invention, the materials used, as well as the shape and the dimensions, may be modified depending on needs.

Should the technical features mentioned in any claim be followed by reference signs, such reference signs were included strictly with the aim of enhancing the understanding of the claims and hence they shall not be deemed restrictive in any manner whatsoever on the scope of each element identified for exemplifying purposes by such reference signs.

1. An apparatus for notching web material comprising longitudinal cutting assembly comprising a guide roller rotatable around a respective axis (C), a first cutting member and a second cutting member disposed downstream of said first cutting member, said first and second cutting members being operable, independently of each other, in movement towards or away between a first inactive position, in which they are respectively spaced away from a web material, fed, in operation, between said guide roller and said first and second cutting members, and a second active position, in which they are adapted to engage said web material, between said guide roller and said first and second cutting members to punch out longitudinal notches on said web material.

2. The apparatus of claim 1, wherein said first cutting member is shaped by a circular blade and is rotatable around a respective axis.

3. The apparatus of claim 1, wherein said second cutting member is shaped by a circular segment blade and is rotatable around a respective axis (E).

4. The apparatus of claim 1, wherein said blade of said second cutting member has a cutting edge which extends between two ends which shape respective angles on said cutting edge.

5. The apparatus of claim 1, wherein said first and second cutting members are carried at the ends of respective arms, which can be operated in a tilting motion.

6. A method for punching out a notch on a web material, wherein it includes the steps of
a. feeding said web material to a longitudinal cutting assembly comprising a guide roller rotated around an axis (C), a first cutting member and a second cutting member placed downstream of said first cutting member;
b. operating said first cutting member in a movement from a first inactive position, in which it is spaced away from said web material, towards a second active position, in which it is able to engage said web material travelling between said guide roller and said first cutting member, punching out a longitudinal notch on said web material;
c. operating said first cutting member in a movement away from said second active position to said first inactive position and, in a suitable phase relationship, moving said second cutting member in approaching movement, from a first inactive position, in which it is arranged spaced away from said web material towards a second active position, in which it is able to engage said web material travelling between said guide roller and said second cutting member, punching out a longitudinal notch for finishing a border of said longitudinal notch punched previously;
d. moving said second cutting member away from said second active position to said first inactive position

7. The method of claim 6, wherein said first cutting member is shaped by a circular blade and rotated around a respective axis (D); said second cutting member being shaped by a circular segment blade and being rotated around a respective axis (E); in which, in said step e., said second cutting member is operated in said second active position in a phase relationship such that said second cutting member engages said edge to be finished of said longitudinal notch previously punched with an end portion of a respective cutting edge.

8. The method of claim 6, wherein said movement towards and said movement away are tilting movements.

9. The method of claim 6, wherein said web material, fed to said longitudinal cutting assembly, bears a plurality of transverse notches at a longitudinal edge of said web material, so that one said longitudinal notch removes a longitudinal portion of said web material between said transversal notches.
